(19) United States
(12) Patent Application Publication
(10) Pub. No.: US 2012/0298912 A1
(43) Pub. Date: Nov. 29, 2012

(54) SPHERICAL HYDROTALCITE COMPOUND AND RESIN COMPOSITION FOR SEALING ELECTRONIC COMPONENT

(76) Inventor: Yasuharu Ono, Nagoya-shi, Aichi (JP)

(21) Appl. No.: 13/576,305

(22) PCT Filed: Jan. 28, 2011
(86) PCT No.: PCT/JP2011/051693

§ 371 Date: Jul. 31, 2012

(30) Foreign Application Priority Data
Feb. 9, 2010 (JP) 2010-026019

(51) Int. Cl. C08K 3/26

(52) U.S. Cl. 252/184

(57) ABSTRACT

A spherical hydrotalcite compound of the present invention is represented by Formula (1) below, having a hydrotalcite compound peak in a powder X-ray diffraction pattern, having a specific surface area of at least 30 m²/g but no greater than 200 m²/g measured by a BET method, and having a secondary particle size median diameter of at least 0.5 μm but no greater than 6 μm on a volume basis measured using a laser diffraction type particle size distribution analyzer.

(MgₓZn₁₋ₓ)ₐAl_{b}(OH)_{c}(CO₃)_{d}.nH₂O (1)

In Formula (1), a, b, c, and d are positive numbers, 0.5≦x≦1, 2a+3b−c−2d=0, and n denotes hydration number and is 0 or a positive number.

### TECHNICAL FIELD

This relates to a spherical hydrotalcite compound that has excellent ionic impurity removal properties and excellent workability when added to a resin and is suitable for use in an electronic material. More specifically, it relates to a spherical hydrotalcite compound that functions as an anion scavenger and that, when added to a resin composition used as a sealing material for a semiconductor, does not increase viscosity, maintains flowability, and has good filling properties, and to a resin composition for sealing an electronic component.

### BACKGROUND ART

Accompanying the increase in fineness of semiconductor wiring and the reduction in chip size in recent years, a sealing resin having higher flowability has been desired, and in connection therewith there is also a desire for improvements in additives such as silica in terms of finer size, higher purity, and maintenance of flowability.

In order to deal with such problems, for example, Patent Document 1 proposes that silica, which is a filler used with an epoxy resin for a semiconductor sealing material, is made spherical or subjected to a surface treatment, thus increasing the flowability.

On the other hand, for the purpose of removing impurity ions in a semiconductor sealing material and improving semiconductor reliability, it has been proposed that a hydrotalcite, which is an inorganic anion exchanger, or a calcined product thereof is added to an epoxy resin, etc., in particular for the purpose of capturing halide ions (ref. e.g. Patent Document 2, Patent Document 3, Patent Document 4, Patent Document 5, Patent Document 6, and Patent Document 7).

For another purpose, that is, for the purpose of imparting cracking resistance during solidification of a hydraulic material such as a cement, Patent Document 8 discloses a layered double hydroxide that is made spherical.
Patent Document 1: JP-A-8-277322 (JP-A denotes a Japanese unexamined patent application publication)
Patent Document 2: JP-A-63-252451
Patent Document 3: JP-A-64-64243
Patent Document 4: JP-A-60-40124
Patent Document 5: JP-A-2000-226438
Patent Document 6: JP-A-60-42418
Patent Document 7: JP-A-2000-159520
Patent Document 8: JP-A-2005-345448

### SUMMARY OF THE INVENTION

### Problems to be Solved by the Invention

Accompanying the recent further increase in fineness of semiconductor chips, additives other than silica have also been required to have finer size, and there is also a desire for resin physical properties such as flowability not to be impaired.

Furthermore, a hydrotalcite has a function of capturing anions, but existing hydrotalcites such as those described in Patent Document 2, Patent Document 3, Patent Document 4, Patent Document 5, Patent Document 6, and Patent Document 7 do not have sufficient ability for capturing anions, and the effect is inadequate in some cases. On the other hand, when a hydrotalcite is made into ultrafine particles, the specific surface area increases and the ability to capture improves, but when fine particles are added to a resin, the viscosity is increased even with a small amount thereof added, and there is the problem that the use thereof in a liquid sealing material is difficult.

A layered double hydroxide that is made spherical as described in Patent Document 8 has not been proposed for use in an electronic material, and its performance is insufficient for improving the reliability of a sealing material for a semiconductor.

It is an object of the present invention to provide a novel hydrotalcite compound that functions as an anion scavenger that can capture harmful anions of a resin composition, etc. and that does not impair the flowability of a resin composition, and a resin composition for sealing an electronic component.

### Means for Solving the Problems

As a result of an intensive investigation in order to solve the above-mentioned problems and discover a novel hydrotalcite compound that can be used in a resin composition, etc., it has been confirmed that spherical particles formed by aggregating an ultrafine particulate hydrotalcite, that is, means described in <1> below, exhibit particularly excellent performance, and the present invention has thus been accomplished.

<1> A spherical hydrotalcite compound represented by Formula (1) below, having a hydrotalcite compound peak in a powder X-ray diffraction pattern, having a specific surface area of at least 30 m²/g but no greater than 200 m²/g measured by a BET method, and having a secondary particle size median diameter of at least 0.5 μm but no greater than 6 μm on a volume basis measured using a laser diffraction type particle size distribution analyzer,

(MgₓZn₁₋ₓ)ₐAl_{b}(OH)_{c}(CO₃)_{d}.nH₂O (1)

wherein a, b, c, and d are positive numbers, 0.5≦x≦1, 2a+3b−c−2d=0, and n denotes hydration number and is 0 or a positive number.

### BRIEF DESCRIPTION OF DRAWINGS

FIG. 1 is A powder X-ray diffraction pattern of a spherical hydrotalcite compound obtained in Example 1.

### EXPLANATION OF REFERENCE NUMERALS AND SYMBOLS

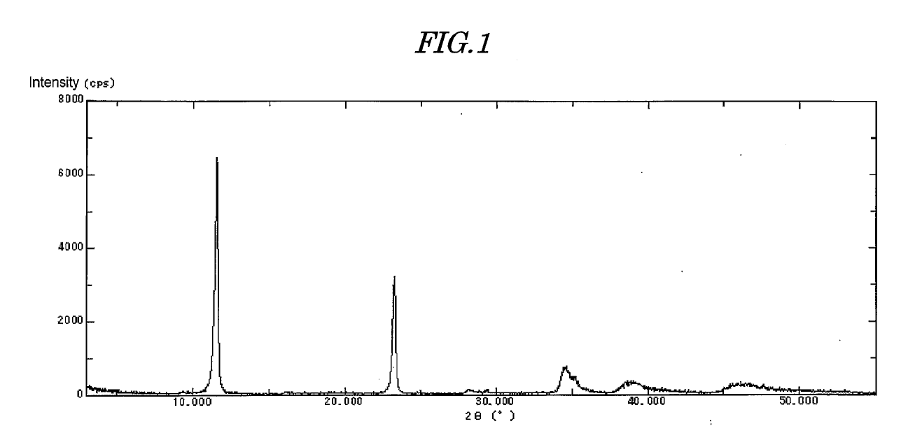

The abscissa of FIG. 1 denotes X-ray diffraction angle 2θ (units: °), and the ordinate denotes diffraction intensity (units: cps).

### MODES FOR CARRYING OUT THE INVENTION

Modes for carrying out the present invention are explained in detail below.

### <Hydrotalcite Compound>

Hydrotalcite denotes in a narrow sense a specific natural mineral, but since a series of compounds having similar compositions and structures show chemically similar properties, they are called hydrotalcite-like compounds, hydrotalcite compounds, hydrotalcite-based compounds, etc. and are known to show similar diffraction patterns due to a layered crystal structure in powder X-ray diffraction measurement.

The spherical hydrotalcite compound of the present invention is a double hydroxide containing magnesium and aluminum as essential components and can be defined by chemical formula, layered crystal structure, and shape (particle size and sphericity).

First, the spherical hydrotalcite compound of the present invention is one represented by Formula (I) below.

(MgₓZn₁₋ₓ)ₐAl_{b}(OH)_{c}(CO₃)_{d}.nH₂O (1)

In Formula (I), a, b, c, and d are positive numbers, 0.5≦x≦1, and 2a+3b−c−2d=0. Furthermore, n denotes hydration number and is 0 or a positive number.

Specific examples of the spherical hydrotalcite compound represented by Formula (I) include Mg_{4.5}Al₂(OH)₁₃CO₃.3.5H₂O, Mg₅Al_{1.5}(OH)₁₃CO₃.3.5H₂O, Mg₆Al₂(OH)₁₆CO₃.4H₂O, Mg₄.2Al₂(OH)_{12.4}CO₃.3.5H₂O, and Mg_{4.3}Al₂(OH)_{12.6}CO₃.3.5H₂O.

The spherical hydrotalcite compound of the present invention has a layered crystal structure and shows a diffraction pattern having sharp diffraction peaks appearing at equal intervals characteristic of a hydrotalcite compound in a powder X-ray diffraction measurement. When measurement is carried out using Cu Kα radiation at 40 kV/150 mA, which are standard measurement conditions for powder X-ray diffraction measurement, a sharp diffraction peak is shown at 2θ=11.4° to 11.7°.

The spherical hydrotalcite compound of the present invention has the shape of truly spherical secondary particles formed by aggregation of microparticles (primary particles) having a high specific surface area. Although it is difficult to measure and define the particle size of primary particles, it is possible to use specific surface area by the BET method as a parameter that reflects the particle size distribution of primary particles. This is because even if secondary particles are formed by aggregation, the smaller the size of primary particles, the larger the specific surface area by the BET method. For use as an ion scavenger, it is preferable for the value for the specific surface area to be large, but in a production step prior to forming secondary particles, the larger the size of the primary particles, due to resistance to aggregation the easier they are to handle, which is advantageous. Therefore, in the present invention the specific surface area by the BET method is at least 30 m²/g but no greater than 200 m²/g, preferably 32 to 70 m²/g, and more preferably 35 to 60 m²/g.

It is preferable for the spherical hydrotalcite compound of the present invention to be truly spherical and have a large secondary particle size since the (melt) viscosity when mixed with a resin is low and the flowability is good, but a small secondary particle size enables fine gaps to be filled. The secondary particle size may be measured using a laser diffraction type particle size distribution analyzer, and with regard to the spherical hydrotalcite compound of the present invention, the median diameter of secondary particles on a volume basis is at least 0.5 μm but no greater than 6 μm, preferably 0.7 to 5.0 μm, and more preferably 2.0 to 4.0 μm.

The sphericity of the spherical hydrotalcite compound of the present invention may be evaluated by measuring the shape of secondary particles. Measurement of shape can be carried out by examination using a laser microscope, a transmission or scanning electron microscope, etc.; a plurality of secondary particles are confirmed on a photographic picture, the diameters in any two mutually perpendicular directions are measured, the difference between the two and the standard deviation relative to the average value of measurements for all the diameters are calculated, and the percentage (%) expressed relative to the average value is defined as an index for the sphericity. It is preferable to carry out measurement of shape for at least 10 secondary particles, and more preferably at least 20 but no greater than 1000. The percentage standard deviation thus calculated is preferably no greater than 20%, more preferably no greater than 10%, and particularly preferably no greater than 5%. With regard to a lower limit, producing those having a very small value causes an increase in cost, and improvement in sphericity is not proportionally reflected in physical properties such as (melt) flowability or (melt) viscosity of the resin composition; it is preferably at least 0.01%, more preferably at least 0.1%, and yet more preferably at least 1%.

### <Process for Producing Hydrotalcite Compound>

The spherical hydrotalcite compound of the present invention may preferably be produced by the production process below, but it is not limited to this production process, and it may be produced by another production process using other starting materials.

The spherical hydrotalcite compound of the present invention may preferably be obtained by a production process comprising a first step of dissolving magnesium chloride and aluminum sulfate at a predetermined ratio in water, then adding a carbonate ion-containing alkali metal hydroxide thereto to thus form a precipitate, and subjecting the precipitate to thermal aging and washing with water to thus form a slurry, and a second step of spray-drying the slurry.

In the first step, the higher the pH when forming the precipitate, the easier it is for the precipitate to be formed, but when it is too high the amount of alkali hydroxide used increases, and the cost for treating liquid waste becomes high. Therefore, the pH is preferably 5 to 14, and more preferably 10 to 13.5. The alkali metal hydroxide used here is preferably sodium hydroxide and/or potassium hydroxide, and more preferably sodium hydroxide.

Furthermore, as a carbonate ion source for the carbonate ion-containing alkali metal hydroxide, it is preferable to add a carbonate; sodium carbonate and/or potassium carbonate is preferable, and sodium carbonate is more preferable.

In the first step, the temperature of the aqueous solution when forming the precipitate from the solution is preferably 1° C. to 100° C., more preferably 10° C. to 80° C., and yet more preferably 20° C. to 60° C. The higher the temperature when subjecting the precipitate to thermal aging, the faster crystallization proceeds and the higher the crystallinity, but when it is too high the growth of crystals is fast, resulting in large particles, and the specific surface area tends to decrease; it is therefore preferably 70° C. to 150° C., and more preferably 80° C. to 120° C. Material having high crystallinity shows a high diffraction intensity in powder X-ray measurement and is preferable since it is chemically stable. More specifically, the diffraction intensity becomes at least 2500 cps at 2θ=11.4° to 11.7° when measured using Cu Kα radiation at 40 kV/150 mA.

In the first step, it is preferable to use deionized water for washing with water, which may be carried out by filtration or using a washing apparatus such as a ceramic filter. It is preferable to carry out washing fully until the electrical conductivity of the washings becomes at least 0 μS/cm but no greater than 100 μS/cm, and more preferably at least 0 μS/cm but no greater than 50 μS/cm. μS/cm (μsiemens/cm) are units expressing electrical conductivity of a liquid, are known to a person skilled in the art, and may be measured by a commercial conductivity meter. The smaller the electrical conductivity, the fewer ions there are present in a liquid.

A slurry that has been subjected to washing with water in the first step may be made into secondary particles by a granulation method such as spray drying. There are two types of spray dryers in terms of the spraying method, that is, a pressurized nozzle atomizer and a rotary disk atomizer, and either may be used preferably; the slurry is made into a mist and dried in a high temperature atmosphere, and collected as a powder. With regard to the high temperature atmosphere for drying, drying is quicker when the temperature is higher, but the sphericity of secondary particles obtained is higher when the temperature is lower because the mist is maintained in a liquid droplet state for a longer time. The temperature is therefore preferably 100° C. to 350° C., more preferably 130° C. to 250° C., and particularly preferably 150° C. to 230° C. For a large-size spray dryer, there is a temperature gradient within the dryer; the temperature of the high temperature atmosphere mentioned above means the maximum temperature within a dryer, and in the case of a hot air blowing method it is almost the same as the temperature of hot air that is blown in. The secondary particles formed by a spray dryer may be collected by a power collection method such as a cyclone or a bag filter.

The spherical hydrotalcite thus obtained may be converted by heating into a no-water-of-crystallization type spherical hydrotalcite compound, for which n in Formula (1) is between 0 and 0.1. The heating temperature in this process may be any as long as it is no greater than 350° C.; when the heating temperature is high the conversion is quick, but if it is too high carbonate ion in the hydrotalcite is released and the crystal structure cannot be maintained. The temperature is therefore preferably 200° C. to 350° C., and more preferably 200° C. to 300° C. The heating time is preferably 0.1 hours to 24 hours. It is also possible to obtain a no- (or low-) water-of-crystallization type spherical hydrotalcite compound in the second step by controlling the heating conditions for the spray dryer.

The no-water-of-crystallization type spherical hydrotalcite compound, for which n in Formula (I) is between 0 and 0.1, has an outstandingly improved ability for capturing divalent or trivalent metal ions such as Cu ion because water of crystallization present between layers of the layered crystal has decreased, and it is effective in preventing migration from copper wiring, which is an electronic material.

### <Compositional Analysis>

With regard to the composition of the hydrotalcite compound obtained, the value for each of x, a, b, c, d, and n in Formula (I) may be determined by determining the number of waters of crystallization by thermal analysis such as thermogravimetric analysis (TG), measuring the elemental ratio of Mg, Zn, and Al by X-ray fluorescence analysis, and measuring the content of carbon and hydrogen by CHN elemental analysis.

### <Metal Impurities>

Since magnesium and aluminum, which are starting materials for the hydrotalcite compound of the present invention, are industrially produced using many natural resources, metal impurities other than magnesium and aluminum can be contained. It is not preferable for a compound containing a heavy metal such as iron, manganese, cobalt, chromium, copper, vanadium, or nickel or a radioactive metal such as uranium or thorium to be contained since there are environmental concerns, or adverse effects such as malfunction of an electronic material are caused.

The total content of the metal impurities is preferably no greater than 1000 weight ppm of the entire hydrotalcite compound of the present invention, more preferably no greater than 500 weight ppm, and yet more preferably no greater than 200 weight ppm. Furthermore, the total content of uranium, thorium, etc. is preferably no greater than 50 weight ppb, more preferably no greater than 25 weight ppb, and particularly preferably no greater than 10 weight ppb. The lower limit may be 0 weight ppm or greater.

### <Ionic Impurities>

The hydrotalcite compound of the present invention contains few ionic impurities that leach out in water. With regard to these ionic impurities, anions are sulfate ion, nitrate ion, chloride ion, etc., and cations are sodium ion, magnesium ion, etc.; the anions may be measured by ion chromatography analysis, the cations may be analyzed by ICP emission spectrometry, and the anions may be analyzed by ion chromatography.

The amount of ionic impurities leaching from the hydrotalcite compound of the present invention is preferably no greater than 500 weight ppm relative to the hydrotalcite compound, more preferably no greater than 100 weight ppm, and particularly preferably no greater than 50 weight ppm. It is preferable for the amount of ionic impurities to be no greater than 500 weight ppm since the reliability of an electronic material can be maintained. The lower limit may be 0 weight ppm or greater.

### <Electrical Conductivity>

Electrical conductivity of supernatant: the amount of ionic material leaching from the spherical hydrotalcite compound of the present invention may be evaluated using, as an index, measurement of the electrical conductivity of a supernatant by, for example, a test of leaching out into deionized water by heating. The larger the amount of impurities or the amount of ionic materials due to hydrolysis, etc. that have leached out, the larger the value for the electrical conductivity, suggesting that the hydrotalcite compound is unstable or contains a large amount of impurities.

As one example, 5 g of hydrotalcite compound is treated in 50 g of deionized water at 125° C. for 20 hours and then filtered; the electrical conductivity of the supernatant measured by a conductivity meter is preferably no greater than 200 μS/cm, more preferably no greater than 150 μS/cm, and particularly preferably no greater than 100 μS/cm. The lower limit may be 0 μS/cm or greater.

### <Cl Ion Exchange Capacity>

The Cl ion exchange capacity of the hydrotalcite compound of the present invention may be easily measured by for example subjecting it to an ion exchange reaction using hydrochloric acid. The Cl ion exchange capacity is preferably at least 1.0 meq/g, more preferably at least 1.2 meq/g, and particularly preferably 1.5 meq/g, and the upper limit is preferably no greater than 10 meq/g. It is preferable for the Cl ion exchange capacity to be in the above range since it is possible to maintain reliability when the compound is used in an electronic material.

The spherical hydrotalcite compound of the present invention can be suitably used in various applications such as sealing, covering, insulation, etc. of an electronic component or an electrical component as a resin composition. Furthermore, the spherical hydrotalcite compound of the present invention can also be used in a stabilizer, a corrosion inhibitor, etc. for a resin such as vinyl chloride.

### <Resin Composition>

With regard to a resin used in a resin composition comprising the spherical hydrotalcite compound of the present invention, it may be either a thermosetting resin such as a phenolic resin, a urea resin, a melamine resin, an unsaturated polyester resin, or an epoxy resin, or a thermoplastic resin such as polyethylene, polystyrene, vinyl chloride, or polypropylene, and a thermosetting resin is preferable. As the thermosetting resin used in the electronic component-sealing resin composition of the present invention, a phenolic resin or an epoxy resin is preferable, and an epoxy resin is particularly preferable.

The epoxy resin may be generally used without limitation as long as it is one that is used as an electronic component-sealing resin. For example, the type thereof is not particularly limited as long as it has at least two epoxy groups per molecule and is curable, and any resin used as a molding material, such as a phenol.novolac type epoxy resin, a bisphenol A epoxy resin, a bisphenol F epoxy resin, or an alicyclic epoxy resin, may be used. Furthermore, in order to enhance the moisture resistance of the electronic component-sealing resin composition of the present invention it is preferable to use as the epoxy resin one having a chloride ion content of at least 0 ppm but no greater than 10 ppm and a hydrolyzable chlorine content of at least 0 ppm but no greater than 1,000 ppm.

The spherical hydrotalcite compound of the present invention may suitably be used with a phenolic resin or epoxy resin for sealing an electronic component, and preferably as a resin composition for sealing an electronic component, the resin composition comprising a curing agent, a curing accelerator, etc., this being defined as the resin composition for sealing an electronic component of the present invention. In addition, with regard to resin compositions for sealing an electronic component that are used in the industry, there are those called solid sealing materials or EMCs, which are solid at normal temperature (20° C.), and those called liquid sealing materials, which are liquid at normal temperature; sealing materials that are solid at normal temperature are heated, melted, and used in a liquid state in a step of sealing an electronic component, and since the melt viscosity or melt flowability is measured and evaluated in a heated state, the same effects are obtained. The viscosity and flowability for a resin composition that is a solid at normal temperature such as a solid sealing material are defined to mean melt viscosity and melt flowability, and for a resin composition that is a liquid at normal temperature such as a liquid sealing material they mean normal viscosity and flowability.

When the electronic component-sealing resin composition of the present invention includes an epoxy resin, any substance known as a curing agent for an epoxy resin composition may be used, and preferred specific examples thereof include an acid anhydride, an amine type curing agent, and a novolac type curing agent. In order to easily lower a viscosity, an acid anhydride is preferable.

As the curing accelerator used in the present invention, any substance known as a curing accelerator for an epoxy resin composition may be used, and preferred specific examples thereof include amine type, phosphorus type, and imidazole type accelerators.

The electronic component-sealing resin composition of the present invention may comprise as necessary a component known as one added to a molding resin. Examples of this component include an inorganic filler, a flame retardant, a coupling agent, a colorant, and a mold release agent. All of these components are known as components added to an epoxy molding resin. Preferred specific examples of the inorganic filler include crystalline silica powder, quartz glass powder, fused silica powder, alumina powder, and talc, and among them crystalline silica powder, quartz glass powder, and fused silica powder are preferable since they are inexpensive. Examples of the flame retardant include antimony oxide, a halogenated epoxy resin, magnesium hydroxide, aluminum hydroxide, a red phosphorus type compound, and a phosphoric acid ester type compound, examples of the coupling agent include silane types and titanium types, and examples of the mold release agent include waxes such as an aliphatic paraffin and a higher fatty alcohol.

In addition to the above-mentioned components, a reactive diluent, a solvent, a thixotropy-imparting agent, etc. may be contained. Specifically, examples of the reactive diluent include butylphenyl glycidyl ether, examples of the solvent include methyl ethyl ketone, and examples of the thixotropy-imparting agent include an organically modified bentonite.

With regard to the proportion of the spherical hydrotalcite compound of the present invention in the resin composition for sealing an electronic component, the larger the proportion, the greater the effect in removing anions tends to be, but since the effect reaches a limit when the proportion is too high, it is preferably 0.01 to 10 parts by weight relative to 100 parts by weight of the resin composition for sealing an electronic component, and more preferably 0.05 to 5 parts by weight.

The resin composition for sealing an electronic component of the present invention may be easily obtained by mixing the above-mentioned starting materials by a known method; for example, each of the above-mentioned starting materials is appropriately mixed, this mixture is kneaded in a heated state by a kneader to give a semi-cured resin composition, this is cooled to room temperature (10° C. to 35° C.), then ground by known means, and tabletted as necessary if it is a solid and used without further treatment if it is a liquid; in accordance with use of the spherical hydrotalcite compound of the present invention, the kneading operation becomes easy, the (melt) flowability when sealing an electronic component improves, and an electronic component having a fine complicated shape can be sealed without defects. When the resin for sealing an electronic component is a liquid at normal temperature, it is used as a liquid sealing material, and since it similarly gives low viscosity and high flowability, an electronic component having a fine complicated shape can be sealed without defects. The resin composition for sealing an electronic component of the present invention is more preferably a liquid sealing material, which easily exhibits low viscosity and high flowability effects, the viscosity being preferably 0.1 to 100 Pa·s at 25° C., and more preferably 1 to 10 Pa·s.

An electronic component-sealing resin composition to which the hydrotalcite compound of the present invention is added may be used in a case in which a device, for example, an active device such as a semiconductor chip, a transistor, a diode, or a thyristor or a passive device such as a capacitor, a resistor, or a coil is mounted on a support member such as a lead frame, a wired tape carrier, a wiring board, glass, or a silicon wafer. The electronic component-sealing resin composition of the present invention may also be used effectively with a printed wiring board.

As a method for sealing a device using the electronic component-sealing resin composition of the present invention, a low pressure transfer molding method, an injection molding method, a compression molding method, an application method, an injection method, etc. may also be used.

The resin composition for sealing an electronic component of the present invention exhibits particularly excellent effects when the sealed electronic component is exposed to a high temperature of at least 100° C. That is, since the resin composition for sealing an electronic component or various types of additives contained therein become prone to release anions such as chloride ion or sulfate ion when exposed to high temperature, thus causing corrosion, a short circuit, etc. of metal electrodes and resulting in a decrease in the reliability of an electronic component, the effect of the hydrotalcite compound of the present invention acting as an anion scavenger is shown strongly in the effect in improving the reliability of the electronic component. The effects are further enhanced when the above-mentioned temperature imposed on the resin composition for sealing an electronic component is 100° C. or above, and particularly 150° C. or above.

### <Application to Wiring Board>

A wiring board is produced by forming a printed wiring substrate utilizing the thermosetting properties of an epoxy resin, etc. to a glass fabric, etc., adhering a copper foil, etc. thereto, and forming a circuit by etching, etc. However, in recent years there have been problems with corrosion and poor insulation due to an increase in density of the circuit, layering of circuits, making an insulating layer film thinner, etc. Such corrosion can be prevented by adding the spherical hydrotalcite compound of the present invention when producing a wiring board. Furthermore, corrosion, etc. of a wiring board can be prevented by adding the spherical hydrotalcite compound of the present invention to an insulating layer for a wiring board. From such viewpoints, a wiring board comprising the spherical hydrotalcite compound of the present invention can suppress the occurrence of defective products due to corrosion, etc. It is preferable to add 0.05 to 5 parts by weight of the spherical hydrotalcite compound of the present invention relative to 100 parts by weight of resin solids content of a wiring board or an insulating layer for a wiring board.

### <Addition to Adhesive>

Electronic components, etc. are mounted on a substrate such as a wiring board using an adhesive. By adding the spherical hydrotalcite compound of the present invention to this adhesive, the occurrence of defective products due to corrosion, etc. can be suppressed. It is preferable to add 0.05 to 5 parts by weight of the spherical hydrotalcite compound of the present invention relative to 100 parts by weight of resin solids content of the adhesive.

By adding the spherical hydrotalcite compound of the present invention to a conductive adhesive, etc. used when wiring or connecting an electronic component, etc. to a wiring board, defects due to corrosion, etc. can be suppressed. Examples of the conductive adhesive include one containing a conductive metal such as silver. It is preferable to add 0.05 to 5 parts by weight of the spherical hydrotalcite compound of the present invention relative to 100 parts by weight of resin solids content of the conductive adhesive.

### <Addition to Varnish>

An electrical product, a printed wiring board, an electronic component, etc. may be produced using a varnish comprising the spherical hydrotalcite compound of the present invention. Examples of the varnish include one containing as a main component a thermosetting resin such as an epoxy resin. It is preferable to add 0.05 to 5 parts by weight of the spherical hydrotalcite compound of the present invention relative to 100 parts by weight of the resin solids content.

### <Addition to Paste>

The spherical hydrotalcite compound of the present invention may be added to a paste containing silver powder, etc. The paste is used as an adjuvant for soldering, etc. in order to improve adhesion between metals that are to be connected. This enables the occurrence of a corrosive material generated from the paste to be suppressed. It is preferable to add 0.05 to 5 parts by weight of the spherical hydrotalcite compound of the present invention relative to 100 parts by weight of resin solids content of the paste.

The spherical hydrotalcite compound of the present invention does not impair flowability when added to a sealing material resin composition and can suppress the release of anions and ionic impurities such as chloride ion from a resin. Because of this, when the spherical hydrotalcite compound of the present invention is used in applications such as the sealing, covering, insulating, etc. of an electronic component or an electrical component, it can enhance the reliability of the electronic component or the electrical component. Furthermore, the spherical hydrotalcite compound of the present invention can be used in a paint, an adhesive, a varnish, a corrosion inhibitor, etc. and can give an effect such as prevention of corrosion, prevention of color transfer, or prevention of odor of a coated material.

### EXAMPLES

The present invention is explained more specifically below by reference to Examples and Comparative Examples.

% and ppm denote weight % and weight ppm respectively unless otherwise specified.

Confirmation of whether a hydrotalcite compound was synthesized or not was carried out from a powder X-ray diffraction pattern obtained by powder X-ray diffraction measurement with Cu Kα radiation using a model RINT2400V powder X-ray diffractometer manufactured by Rigaku Corporation under X-ray conditions of 40 kV/150 mA. CHN elemental analysis was carried out using a Yanaco model MT-5 CHN-corder, X-ray fluorescence analysis was carried out using a System 3270E X-ray fluorescence analyzer manufactured by Rigaku Corporation, and analysis was carried out by the fundamental parameter method. The amount of water of crystallization was measured using a model TG/DTA220 thermogravimetric analyzer manufactured by Seiko Electronic Industry Co., Ltd., and x, a, b, c, d, and n in Formula (I) were calculated based on the measurement results.

### Example 1

246.5 g of magnesium sulfate heptahydrate and 126.1 g of aluminum sulfate hexadecahydrate were dissolved in 1 L of deionized water, and the pH was adjusted to 10.5 by adding a solution of 53.0 g of sodium carbonate and 60 g of sodium hydroxide in 1 L of deionized water to the above solution while maintaining it at 25° C. It was then aged at 98° C. for 24 hours. After cooling, deionized water was added to the precipitate while filtering using a membrane filter, and it was washed until the electrical conductivity of the filtrate became no greater than 100 μS/cm, thus giving a slurry having a concentration of 5 weight %. This slurry was subjected to spray drying while stirring by a spray dryer (DL-41, Yamato Scientific Co., Ltd.) at a drying temperature of 180° C., a spray pressure of 0.16 MPa, and a spray rate of about 150 mL/min, thus giving spherical particles of Mg₄.5Al₂(OH)₁₃CO₃.3.5H₂O (hydrotalcite compound A). From the results of thermogravimetric analysis, X-ray fluorescence analysis, and CHN elemental analysis, the composition of hydrotalcite compound A (inorganic ion scavenger A) was determined to be Mg₄.5Al₂(OH)₁₃CO₃^{˜}3.5H₂O. Furthermore, this compound was subjected to powder X-ray diffraction (XRD) measurement. This diffraction pattern is shown in FIG. 1. From the results, there was a peak due to hydrotalcite, and the peak intensity at 20=11.52° was 6000 cps.

### Example 2

256.4 g of magnesium nitrate hexahydrate and 150.1 g of aluminum nitrate nonahydrate were dissolved in 1 L of deionized water, and the pH was adjusted to 10.5 by adding a solution of 53.0 g of sodium carbonate and 60 g of sodium hydroxide in 1 L of deionized water to the above solution while maintaining it at 25° C. It was then aged at 98° C. for 24 hours. After cooling, the precipitate was washed with deionized water until the electrical conductivity of the filtrate became no greater than 100 μS/cm, thus giving a slurry having a concentration of 5 weight %. This slurry was subjected to spray drying while stirring by a spray dryer (DL-41, Yamato Scientific Co., Ltd.) at a drying temperature of 180° C., a spray pressure of 0.16 MPa, and a spray rate of about 150 mL/min, thus giving spherical particles (hydrotalcite compound B). From the results of thermogravimetric analysis, X-ray fluorescence analysis, and CHN elemental analysis, the composition of hydrotalcite compound B was determined to be Mg₄.5Al₂(OH)₁₃CO₃.3.5H₂O.

### Example 3

203.3 g of magnesium chloride hexahydrate and 96.6 g of aluminum chloride nonahydrate were dissolved in 1 L of deionized water, and the pH was adjusted to 10.5 with a solution of 53.0 g of sodium carbonate and 60 g of sodium hydroxide in 1 L of deionized water while maintaining the above solution at 25° C. It was then aged at 98° C. for 24 hours. After cooling, the precipitate was washed with deionized water until the electrical conductivity of the filtrate became no greater than 100 μS/cm, thus giving a slurry having a concentration of 5 weight %. This slurry was subjected to spray drying while stirring by a spray dryer (DL-41, Yamato Scientific Co., Ltd.) at a drying temperature of 180° C., a spray pressure of 0.16 MPa, and a spray rate of about 150 mL/min, thus giving spherical particles (hydrotalcite compound C). From the results of thermogravimetric analysis, X-ray fluorescence analysis, and CHN elemental analysis, the composition of hydrotalcite compound C was determined to be Mg_{4.5}Al₂(OH)₁₃CO₃.3.5H₂O.

### Example 4

246.5 g of magnesium sulfate heptahydrate and 105.1 g of aluminum sulfate hexadecahydrate were dissolved in 1 L of deionized water, and the pH was adjusted to 10.5 with a solution of 53.0 g of sodium carbonate and 60 g of sodium hydroxide in 1 L of deionized water while maintaining the above solution at 25° C. It was then aged at 98° C. for 24 hours. After cooling, the precipitate was washed with deionized water until the electrical conductivity of the filtrate became no greater than 100 μS/cm, thus giving a slurry having a concentration of 5 weight %. This slurry was subjected to spray drying while stirring by a spray dryer (DL-41, Yamato Scientific Co., Ltd.) at a drying temperature of 180° C., a spray pressure of 0.16 MPa, and a spray rate of about 150 mL/min, thus giving spherical particles (hydrotalcite compound D). From the results of thermogravimetric analysis, X-ray fluorescence analysis, and CHN elemental analysis, the composition of hydrotalcite compound D was determined to be Mg₆Al₂(OH)₁₆CO₃.4H₂O.

### Example 5

256.4 g of magnesium nitrate hexahydrate and 125.0 g of aluminum nitrate nonahydrate were dissolved in 1 L of deionized water, and the pH was adjusted to 10.5 with a solution of 53.0 g of sodium carbonate and 60 g of sodium hydroxide in 1 L of deionized water while maintaining the above solution at 25° C. It was then aged at 98° C. for 24 hours. After cooling, the precipitate was washed with deionized water until the electrical conductivity of the filtrate became no greater than 100 μS/cm, thus giving a slurry having a concentration of 5 weight %. This slurry was subjected to spray drying while stirring by a spray dryer (DL-41, Yamato Scientific Co., Ltd.) at a drying temperature of 180° C., a spray pressure of 0.16 MPa, and a spray rate of about 150 mL/min, thus giving spherical particles (hydrotalcite compound E). From the results of thermogravimetric analysis, X-ray fluorescence analysis, and CHN elemental analysis, the composition of hydrotalcite compound E was determined to be Mg₆Al₂(OH)₁₆CO₃.4H₂O.

### Example 6

203.3 g of magnesium chloride hexahydrate and 80.5 g of aluminum chloride nonahydrate were dissolved in 1 L of deionized water, and the pH was adjusted to 10.5 with a solution of 53.0 g of sodium carbonate and 60 g of sodium hydroxide in 1 L of deionized water while maintaining the above solution at 25° C. It was then aged at 98° C. for 24 hours. After cooling, the precipitate was washed with deionized water until the electrical conductivity of the filtrate became no greater than 100 μS/cm, thus giving a slurry having a concentration of 5 weight %. This slurry was subjected to spray drying while stirring by a spray dryer (DL-41, Yamato Scientific Co., Ltd.) at a drying temperature of 180° C., a spray pressure of 0.16 MPa, and a spray rate of about 150 mL/min, thus giving spherical particles (hydrotalcite compound F). From the results of thermogravimetric analysis, X-ray fluorescence analysis, and CHN elemental analysis, the composition of hydrotalcite compound F was determined to be Mg₆Al₂(OH)₁₆CO₃.4H₂O.

### Example 7

Hydrotalcite compound A was heated and dried at 250° C. for 24 hours, giving a no-water-of-crystallization type spherical hydrotalcite compound (hydrotalcite compound G). From the results of thermogravimetric analysis, X-ray fluorescence analysis, and CHN elemental analysis, the composition of hydrotalcite compound G was determined to be Mg₄.5Al₂(OH)₁₃CO₃.

### Example 8

Hydrotalcite compound D was heated and dried at 250° C. for 24 hours, giving a no-water-of-crystallization type spherical hydrotalcite compound (hydrotalcite compound H). From the results of thermogravimetric analysis, X-ray fluorescence analysis, and CHN elemental analysis, the composition of hydrotalcite compound H was determined to be Mg₆Al₂(OH)₁₆CO₃.

### Comparative Example 1

203.3 g of magnesium chloride hexahydrate and 96.6 g of aluminum chloride hexahydrate were dissolved in 1 L of deionized water, and the pH was adjusted to 10.5 with a solution of 60 g of sodium hydroxide in 1 L of deionized water while maintaining the above solution at 25° C. It was then aged at 98° C. for 24 hours. After cooling, the precipitate was washed with deionized water until the electrical conductivity of the filtrate became no greater than 100 μS/cm, thus giving a slurry having a concentration of 5 weight %. This slurry was subjected to spray drying while stirring by a spray dryer (DL-41, Yamato Scientific Co., Ltd.) at a drying temperature of 180° C., a spray pressure of 0.16 MPa, and a spray rate of about 150 mL/min, thus giving spherical particles (Comparative compound 1). From the results of thermogravimetric analysis, X-ray fluorescence analysis, and CHN elemental analysis, the composition of Comparative compound 1 was determined to be Mg_{4.5}Al₂(OH)₁₃CO₃.3.5H₂O.

### Comparative Example 2

203.3 g of magnesium chloride hexahydrate and 80.5 g of aluminum chloride hexahydrate were dissolved in 1 L of deionized water, and the pH was adjusted to 10.5 with a solution of 60 g of sodium hydroxide in 1 L of deionized water while maintaining the above solution at 25° C. It was then aged at 98° C. for 24 hours. After cooling, the precipitate was washed with deionized water until the electrical conductivity of the filtrate became no greater than 100 μS/cm, thus giving a slurry having a concentration of 5 weight %. This slurry was subjected to spray drying while stirring by a spray dryer (DL-41, Yamato Scientific Co., Ltd.) at a drying temperature of 180° C., a spray pressure of 0.16 MPa, and a spray rate of about 150 mL/min, thus giving spherical particles (Comparative compound 2). From the results of thermogravimetric analysis, X-ray fluorescence analysis, and CHN elemental analysis, the composition of Comparative compound 2 was determined to be Mg₆Al₂(OH)₁₆CO₃.4H₂O.

### Comparative Example 3

246.5 g of magnesium sulfate heptahydrate and 126.1 g of aluminum sulfate hexadecahydrate were dissolved in 1 L of deionized water, and the pH was adjusted to 10.5 with a solution of 53.0 g of sodium carbonate and 60 g of sodium hydroxide in 1 L of deionized water while maintaining the above solution at 25° C. It was then aged at 98° C. for 24 hours. After cooling, the precipitate was washed with deionized water until the electrical conductivity of the filtrate became no greater than 100 μS/cm, dried by allowing to stand at 150° C., and ground, thus giving a hydrotalcite compound (Comparative compound 3). From the results of thermogravimetric analysis, X-ray fluorescence analysis, and CHN elemental analysis, the composition of Comparative compound 3 was determined to be Mg₆Al₂(OH)₁₆CO₃.4H₂O.

### Comparative Example 4

Comparative compound 3 was dried at 250° C. for 24 hours, giving a no-water-of-crystallization type spherical hydrotalcite compound (Comparative compound 4). From the results of thermogravimetric analysis, X-ray fluorescence analysis, and CHN elemental analysis, the composition of Comparative compound 4 was determined to be Mg₄.5Al₂(OH)₁₃CO₃.

### Comparative Example 5

DHT-4A manufactured by Kyowa Chemical Industry Co., Ltd., which is a commercial hydrotalcite compound, was defined as Comparative compound 5.

### Basic Physical Properties of Ion Scavenger

### <Measurement of BET Specific Surface Area>

The specific surface area of hydrotalcite compound A that was obtained was measured in accordance with JIS Z8830 ‘determination of the specific surface area of powders (solids) by gas adsorption method’. This result is shown in Table 1.

Similarly, hydrotalcite compounds B, C, D, E, and F, and Comparative compounds 1 to 4 were subjected to measurement of specific surface area. The results are also shown in Table 1.

### <Measurement of Average Secondary Particle Size and Particle Size Distribution>

Measurement of secondary particle size (median diameter) and particle size distribution of a spherical hydrotalcite compound was carried out by dispersing the spherical hydrotalcite compound in deionized water, treating it with 70 W ultrasound waves for at least 2 minutes, then measuring using a laser diffraction type particle size distribution analyzer, and analyzing the result on a volumetric basis. Specifically, measurement was carried out using an ‘MS2000’ laser diffraction type particle size distribution measurement system manufactured by Malvern Instruments Ltd.

### <Measurement of Ion Exchange Capacity>

1.0 g of spherical hydrotalcite compound A was placed in a 100 mL polyethylene bottle, 50 mL of a 0.1 mol/L concentration aqueous solution of hydrochloric acid was charged thereinto, and the bottle was hermetically sealed and agitated at 40° C. for 24 hours. Subsequently, this solution was filtered using a membrane filter having a pore size of 0.1 μm, and the chloride ion concentration in the filtrate was measured by ion chromatography. This chloride ion value was divided by a value obtained by measuring a chloride ion concentration by carrying out the same operation without adding the hydrotalcite compound, thus giving the chloride ion exchange capacity (meq/g). The results are given also in Table 2.

Hydrotalcite compounds B to F and Comparative compounds 1 to 4 were similarly treated and chloride ion exchange capacity (meq/g) was determined. The results are also shown in Table 2.

<Ion chromatography analysis conditions>
Measurement equipment: model DX-300 manufactured by DIONEX
Separating column: IonPac AS4A-SC (manufactured by DIONEX)
Guard column: lonPac AG4A-SC (manufactured by DIONEX)
Eluent: 1.8 mM Na₂CO₃/1.7 mM NaHCO₃ aqueous solution
Flow rate: 1.5 mL/min
Suppressor: ASRS-I (recycle mode)

Chloride ion was measured under the analysis conditions given above.

### <Measurement of Amount of Impurity Ions Leaching Out>

5.0 g of spherical hydrotalcite compound A was placed in a 100 mL sealable polytetrafluoroethylene pressure-resistant container, 50 mL of deionized water was further added thereto, and the container was sealed and treated at 125° C. for 20 hours. After cooling, this solution was filtered using a membrane filter having a pore size of 0.1 μm, and the sulfate ion, nitrate ion, and chloride ion concentrations of the filtrate were measured by ion chromatography (nitrate ion and chloride ion were measured in addition to sulfate ion under the analysis conditions given above. Measurement below was carried out by the same method). Furthermore, sodium ion and magnesium ion concentrations in the filtrate were measured by a method of ICP optical emission spectrometry in accordance with JIS K0116-2003. The numerical value obtained by multiplying the sum of the measurement values by 10 was defined as the amount of ionic impurities (ppm). The result is given in Table 2.

Similarly, hydrotalcite compounds B to F and Comparative compounds 1 to 4 were subjected to measurement of the amount of impurity ions leaching out. The results are shown in Table 2.

### <Measurement of Electrical Conductivity of Supernatant>

5.0 g of hydrotalcite compound Al was placed in a 100 mL sealable polytetrafluoroethylene pressure-resistant container, 50 mL of deionized water was further added thereto, and the container was sealed and treated at 125° C. for 20 hours. After cooling, this solution was filtered using a membrane filter having a pore size of 0.1 μm, and the electrical conductivity (μS/cm) of the filtrate were measured by an electrical conductivity meter. The result is given in Table 2.

Similarly, hydrotalcite compounds B to F and Comparative compounds 1 to 4 were subjected to measurement of electrical conductivity of the supernatant. The results are shown in Table 2.

### Example 9

### Measurement of Viscosity and Corrosion Test of Aluminum Wiring

### <Preparation of Sample>

72 parts of a bisphenol epoxy resin (epoxy equivalent 190), 28 parts of an amine-based curing agent (molecular weight 252), 100 parts of fused silica, 1 part of an epoxy-based silane coupling agent, and 0.5 parts of hydrotalcite compound A were weighed, mixed using a spatula, etc., and further mixed using a three roll mill. Furthermore, this mixture was degassed at 35° C. using a vacuum pump for 1 hour.

A thickness of 1 mm of the resin thus mixed was applied onto two lines of aluminum wiring printed on a glass plate (line width 20 μm, film thickness 0.15 μm, length 1000 mm, line gap 20 μm, resistance about 9 kΩ) and cured at 120° C. (aluminum wiring sample A).

### <Viscosity Measurement>

The viscosity of the mixed resin prior to curing was measured (25° C.) in accordance with JIS K7117-1 using a model B viscometer. The result is shown in Table 2.

### <Corrosion Test>

The epoxy-coated aluminum wiring sample A prepared above was subjected to a pressure cooker test (PCT) (equipment used: PLAMOUNT-PM220 manufactured by Kusumoto Chemicals, Ltd., 130° C.±2° C., 85% RH (±5%), applied voltage 40V, time 40 hours). The resistance of the aluminum wiring of the positive electrode was measured before and after the PCT, and evaluation was made based on the percentage change in resistance. Furthermore, the extent of corrosion of the aluminum wiring was examined from the backside using a microscope. The results are shown in Table 2.

### Example 10

Aluminum wiring sample B was prepared in the same manner as in Example 9 except that hydrotalcite compound B was used instead of hydrotalcite compound A, and viscosity measurement and the corrosion test were carried out. The results are shown in Table 2.

### Example 11

Aluminum wiring sample C was prepared in the same manner as in Example 9 except that hydrotalcite compound C was used instead of hydrotalcite compound A, and viscosity measurement and the corrosion test were carried out. The results are shown in Table 2.

### Example 12

Aluminum wiring sample D was prepared in the same manner as in Example 9 except that hydrotalcite compound D was used instead of hydrotalcite compound A, and viscosity measurement and the corrosion test were carried out. The results are shown in Table 2.

### Example 13

Aluminum wiring sample E was prepared in the same manner as in Example 9 except that hydrotalcite compound E was used instead of hydrotalcite compound A, and viscosity measurement and the corrosion test were carried out. The results are shown in Table 2.

### Example 14

Aluminum wiring sample F was prepared in the same manner as in Example 9 except that hydrotalcite compound F was used instead of hydrotalcite compound A, and viscosity measurement and the corrosion test were carried out. The results are shown in Table 2.

### Example 15

Aluminum wiring sample G was prepared in the same manner as in Example 9 except that hydrotalcite compound G was used instead of hydrotalcite compound A, and viscosity measurement and the corrosion test were carried out. The results are shown in Table 2.

### Example 16

Aluminum wiring sample H was prepared in the same manner as in Example 9 except that hydrotalcite compound H was used instead of hydrotalcite compound A, and viscosity measurement and the corrosion test were carried out. The results are shown in Table 2.

### Comparative Reference Example

Aluminum wiring comparative reference sample was prepared in the same manner as in Example 9 except that hydrotalcite compound A was not used, and viscosity measurement and the corrosion test were carried out. The results are shown in Table 2.

### Comparative Example 6

Aluminum wiring comparative sample 1 was prepared in the same manner as in Example 9 except that Comparative compound 1 was used instead of hydrotalcite compound A, and viscosity measurement and the corrosion test were carried out. The results are shown in Table 2.

### Comparative Example 7

Aluminum wiring comparative sample 2 was prepared in the same manner as in Example 9 except that Comparative compound 2 was used instead of hydrotalcite compound A, and viscosity measurement and the corrosion test were carried out. The results are shown in Table 2.

### Comparative Example 8

Aluminum wiring comparative sample 3 was prepared in the same manner as in Example 9 except that Comparative compound 3 was used instead of hydrotalcite compound A, and viscosity measurement and the corrosion test were carried out. The results are shown in Table 2.

### Comparative Example 9

Aluminum wiring comparative sample 4 was prepared in the same manner as in Example 9 except that Comparative compound 4 was used instead of hydrotalcite compound A, and viscosity measurement and the corrosion test were carried out. The results are shown in Table 2.

### Comparative Example 10

Aluminum wiring comparative sample 5 was prepared in the same manner as in Example 9 except that Comparative compound 5 was used instead of hydrotalcite compound A, and viscosity measurement and the corrosion test were carried out. The results are shown in Table 2.

TABLE 1

| | BET | Secondary | | | |
|---|---|---|---|---|---|
| | specific | particle | Cl ion | Amount | Electrical |
| | surface | size (median | exchange | of ionic | conduc- |
| | area | diameter) | capacity | impurities | tivity |
| Sample | (m²/g) | (μm) | (meq/g) | (ppm) | (μS/cm) |
| Inorganic ion | 35 | 3.5 | 2.9 | <100 | 120 |
| scavenger A | | | | | |
| Inorganic ion | 36 | 3.7 | 2.8 | <100 | 130 |
| scavenger B | | | | | |
| Inorganic ion | 35 | 3.6 | 3.1 | <100 | 110 |
| scavenger C | | | | | |
| Inorganic ion | 36 | 3.6 | 3.0 | <100 | 110 |
| scavenger D | | | | | |
| Inorganic ion | 37 | 3.5 | 2.9 | <100 | 120 |
| scavenger E | | | | | |
| Inorganic ion | 37 | 3.8 | 2.9 | <100 | 120 |
| scavenger F | | | | | |
| Inorganic ion | 38 | 3.5 | 0.8 | <100 | 150 |
| scavenger G | | | | | |
| Inorganic ion | 37 | 3.6 | 0.9 | <100 | 140 |
| scavenger H | | | | | |
| Comparative | 11 | 3.6 | 0.2 | 430 | 400 |
| compound 1 | | | | | |
| Comparative | 12 | 3.7 | 0.2 | 440 | 390 |
| compound 2 | | | | | |
| Comparative | 39 | 0.1 | 2.9 | <100 | 120 |
| compound 3 | | | | | |
| Comparative | 40 | 0.1 | 0.8 | <100 | 150 |
| compound 4 | | | | | |
| Comparative | 11 | 0.4 | 2.2 | 300 | 350 |
| compound 5 | | | | | |

TABLE 2

| | | Percentage | |
|---|---|---|---|
| | | change of | |
| | Viscosity of | resistance of | Extent of corrosion |
| | resin mixture | positive | of aluminum wiring |
| | (Pa · s) | electrode (%) | (microscope) |
| Example 9 | 8.0 | 3.0 | Slight corrosion |
| Example 10 | 8.2 | 3.1 | Slight corrosion |
| Example 11 | 8.4 | 3.2 | Slight corrosion |
| Example 12 | 8.1 | 3.2 | Slight corrosion |
| Example 13 | 8.3 | 3.3 | Slight corrosion |
| Example 14 | 8.1 | 3.1 | Slight corrosion |
| Example 15 | 8.5 | 1.5 | No corrosion |
| | | | observed |
| Example 16 | 8.3 | 1.7 | No corrosion |
| | | | observed |
| Comparative | 8.0 | 12.0 | Severe corrosion |
| Reference Example | | | |
| Comparative | 8.1 | 6.0 | Large amount |
| Example 6 | | | of corrosion |
| Comparative | 8.0 | 6.1 | Large amount |
| Example 7 | | | of corrosion |
| Comparative | 20.0 | 2.9 | Slight corrosion |
| Example 8 | | | |
| Comparative | 30.0 | 1.5 | No corrosion |
| Example 9 | | | observed |
| Comparative | 10.1 | 5.9 | Large amount |
| Example 10 | | | of corrosion |

As is clear from Table 2, when the spherical hydrotalcite compound of the present invention is added to a liquid resin, the viscosity does not increase, and the workability is not impaired. Furthermore, the resin composition for sealing an electronic component of the present invention has a high effect in suppressing corrosion of aluminum wiring and provides an electronic component having high reliability.

Furthermore, with regard to the sphericity of the spherical hydrotalcite compounds obtained in Examples 1 to 8 and Comparative Examples 1 to 5, 100 secondary particles were checked on a photographic picture taken by a scanning electron microscope (Model JSM-6330F, JEOL), the diameters thereof in any two mutually perpendicular directions were measured, the difference between the two and the standard deviation relative to the average value of measurements for all the diameters were calculated, and the percentage (%) expressed relative to the average value was defined as an index for the sphericity. The closer to 0 the value for the sphericity, the closer to a true sphere.

The sphericity (%) of secondary particles of each spherical hydrotalcite compound (inorganic ion scavengers A to H and Comparative compounds 1 to 5) is summarized in Table 3 below.

TABLE 3

| | Sphericity |
|---|---|
| | (%) |
| Inorganic ion scavenger A | 1.8 |
| Inorganic ion scavenger B | 2.0 |
| Inorganic ion scavenger C | 2.1 |
| Inorganic ion scavenger D | 1.9 |
| Inorganic ion scavenger E | 2.0 |
| Inorganic ion scavenger F | 2.0 |
| Inorganic ion scavenger G | 2.4 |
| Inorganic ion scavenger H | 2.5 |
| Comparative compound 1 | 1.9 |
| Comparative compound 2 | 2.0 |
| Comparative compound 3 | 17.0 |
| Comparative compound 4 | 21.0 |
| Comparative compound 5 | 77.0 |

### INDUSTRIAL APPLICABILITY

With the spherical hydrotalcite of the present invention there is little leaching out of ionic impurities, and increase in viscosity when mixed with a resin is suppressed. The resin composition for sealing an electronic component comprising the spherical hydrotalcite of the present invention has an excellent effect in suppressing corrosion of aluminum wiring, and an electronic component having high reliability is therefore obtained. Furthermore, since the spherical hydrotalcite of the present invention is an anion scavenger, it can be used in various applications, in addition to sealing, covering, insulation, etc. of an electrical component, such as a stabilizer or corrosion inhibitor for a resin such as vinyl chloride.

1. (canceled)

2. (canceled)

3. (canceled)

4. (canceled)

5. (canceled)

6. (canceled)

7. (canceled)

8. (canceled)

9. (canceled)

10. (canceled)

11. A process for producing the spherical hydrotalcite compound, comprising
a step of dissolving a magnesium salt and an aluminum salt in water at a predetermined ratio, thus obtaining a solution,
a step of adding a carbonate ion-containing alkali metal hydroxide to the solution, thus forming a precipitate,
a step of subjecting the precipitate to thermal aging and washing with water, thus forming a slurry, and
a step of spray-drying the slurry, thus obtaining a spherical hydrotalcite compound represented by Formula (I) below, the spherical hydrotalcite compound having a hydrotalcite compound peak in a powder X-ray diffraction pattern, having a specific surface area of at least 30 m²/g but no greater than 200 m²/g measured by a BET method, and having a secondary particle size median diameter of at least 0.5 μm but no greater than 6 μm on a volume basis measured using a laser diffraction type particle size distribution analyzer,
(MgₓZn₁₋ₓ)ₐAl_{b}(OH)_{c}(CO₃)_{d}.nH₂O (1)
where a, b, c, and d are positive numbers, 0.5≦x≦1, 2a+3b−c−2d=0, and n denotes hydration number and is 0 or a positive number.

12. The process for producing the spherical hydrotalcite compound according to claim 11, wherein the magnesium salt is magnesium sulfate and the aluminum salt is aluminum sulfate.

13. The process for producing the spherical hydrotalcite compound according to claim 11, wherein said spray-drying is carried out in an atmosphere at 100° C. to 350° C.

14. The process for producing a spherical hydrotalcite compound according to claim 11, wherein the spherical hydrotalcite compound has a sharp diffraction peak between diffraction angles 2θ=11.4° to 11.7° by powder X-ray diffraction measurement using Cu Kα radiation, the diffraction peak having a diffraction intensity of at least 2500 cps under measurement conditions of 40 kV/150 mA.

15. The process for producing a spherical hydrotalcite compound according to claim 11, wherein in Formula (I) n=0 to 0.1.

16. The process for producing a spherical hydrotalcite compound according to claim 11, wherein in Formula (I) n=0.

17. The process for producing a spherical hydrotalcite compound according to claim 11, wherein the spherical hydrotalcite compound has a secondary particle sphericity of 0.01% to 20%.
